(19) United States
(12) Patent Application Publication
(10) Pub. No.: US 2024/0062551 A1
(43) Pub. Date: Feb. 22, 2024

(54) INFORMATION PROCESSING APPARATUS

(71) Applicant: DENSO TEN Limited, Kobe-shi (JP)

(72) Inventors: Koji OHNISHI, Kobe-shi (JP); Naoshi KAKITA, Kobe-shi (JP); Takayuki OZASA, Kobe-shi (JP)

(73) Assignee: DENSO TEN Limited, Kobe-shi (JP)

(21) Appl. No.: 18/122,929

(22) Filed: Mar. 17, 2023

(30) Foreign Application Priority Data
Aug. 16, 2022 (JP) 2022-129577

(51) Int. Cl. G06V 20/56; G06T 7/80; G06T 7/269; G06V 10/147; G06V 10/96

(52) U.S. Cl. CPC G06V 20/56; G06T 7/80; G06T 7/269; G06V 10/147; G06V 10/96; G06T 2207/30252; G06V 2201/07

(57) ABSTRACT

An information processing apparatus according to an embodiment includes a controller. The controller is configured to estimate an attitude of an onboard camera, sequentially perform a first calibration process and a second calibration process of the onboard camera, and change a detection accuracy of an image recognition process of a captured image captured by the onboard camera depending on completion statuses of the first calibration process and the second calibration process.

### BACKGROUND OF THE INVENTION

### Field of the Invention

The invention relates to an information processing apparatus, an information processing method and a computer-readable recording medium.

### Description of the Background Art

There is a vehicle control system that detects a detection target by performing an image recognition process on a captured image captured by an onboard camera, and uses a detection result for driving support of a vehicle. Since an attitude of the onboard camera to be mounted on the vehicle has a large influence on a detection accuracy of the detection target, the vehicle control system performs a calibration process that adjusts the attitude of the onboard camera for a predetermined period after mounting of the onboard camera.

However, the vehicle control system cannot sufficiently improve the detection accuracy of the detection target by the image recognition process until the calibration process is completed. Thus, there is a vehicle control system that suppresses the driving support during a period from a start to a completion of the calibration process (for example, refer to Japanese Published Unexamined Patent Application No. 2019-6275).

However, if the driving support is suppressed until the completion of the calibration process, a problem that a start time of the driving support is delayed occurs.

### SUMMARY OF THE INVENTION

According to one aspect of the invention, an information processing apparatus includes a controller. The controller is configured to (i) sequentially perform a first calibration process and a second calibration process of an onboard camera, and (ii) change a detection accuracy of an image recognition process of a captured image captured by the onboard camera depending on completion statuses of the first calibration process and the second calibration process.

It is an object of the invention to provide an information processing apparatus, an information processing method, and a computer-readable recording medium capable of allowing the driving support to be started earlier.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 is an overview illustration (No. 1) of an attitude estimation method according to an embodiment;

FIG. 2 is an overview illustration (No. 2) of the attitude estimation method according to the embodiment;

FIG. 3 is an overview illustration (No. 3) of the attitude estimation method according to the embodiment;

FIG. 4 is a block diagram illustrating an example configuration of an onboard device according to the embodiment;

FIG. 5 is an illustration (No. 1) of a road surface ROI and a superimposed ROI;

FIG. 6 is an illustration (No. 2) of the road surface ROI and the superimposed ROI;

FIG. 7 is a block diagram illustrating an example configuration of an attitude estimator;

FIG. 8 is an illustration of one example of an instruction from the onboard device according to the embodiment to an external device;

FIG. 9 is an illustration of one example of the instruction from the onboard device according to the embodiment to the external device;

FIG. 10 is a flowchart illustrating a processing procedure performed by the onboard device according to the embodiment; and

FIG. 11 is a flowchart illustrating the processing procedure performed by the onboard device according to the embodiment.

### DESCRIPTION OF THE EMBODIMENTS

An embodiment of an information processing apparatus, an information processing method and a computer-readable recording medium disclosed in the present application will be described in detail below with reference to the accompanying drawings. The invention is not limited to the embodiment described below. In the following, it will be assumed that the information processing apparatus according to the embodiment is an onboard device 10 mounted on a vehicle. The onboard device 10 is, for example, a drive recorder.

The onboard device 10 according to the embodiment is a device that records an image around the vehicle captured by an onboard camera (hereinafter, referred to as a “camera 11” (refer to FIG. 4)). The onboard device 10, by executing a predetermined computer program, estimates a mounting attitude of the camera 11 mounted on the vehicle, and sequentially performs a first calibration process and a second calibration process using the estimated attitude of the camera 11. Furthermore, the onboard device 10, by executing the predetermined computer program, changes a detection accuracy of an image recognition of the captured image captured by the camera 11 depending on completion statuses of the first calibration process and the second calibration process.

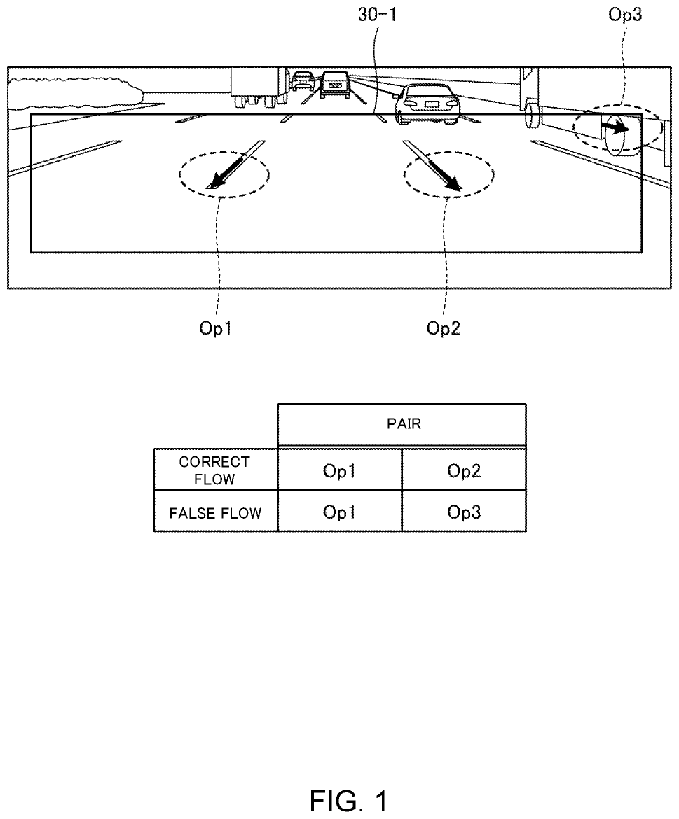

A method of estimating the mounting attitude of the camera 11 performed by the onboard device 10 will be described with reference to FIG. 1 to FIG. 3. FIG. 1 to FIG. 3 are respectively overview illustrations (No. 1) to (No. 3) of an attitude estimation method according to the embodiment. Here, an attitude estimation method according to a comparative example and the problem thereof will be described more specifically prior to the description of the attitude estimation method according to the embodiment. FIG. 1 illustrates the content of the problem.

In the attitude estimation method according to the comparative example, feature points on a road surface are extracted from a rectangular ROI (Region Of Interest) set in a captured image, and an attitude of an onboard camera is estimated based on optical flows indicating the motion of the feature points across frames.

When the attitude of the camera 11 is estimated based on optical flows of feature points on a road surface, the feature points on the road surface to be extracted include the corner portions of road surface markings such as lanes.

However, as illustrated in FIG. 1, for example, the lane markers in the captured image appear to converge toward the vanishing point in perspective. Thus, when a rectangular ROI (hereinafter, referred to as a “rectangular ROI 30-1”) is used, the feature points of three-dimensional objects other than the road surface are more likely to be extracted. in the upper left and upper right of the rectangular ROI 30-1.

FIG. 1 illustrates an example in which optical flows Op1, Op2 are extracted based on the feature points on the road surface, and an optical flow Op3 is extracted based on the feature points of the three-dimensional objects other than the road surface.

Here, for example, when an algorithm estimates pairs of parallel line segments in a real space, and estimates the attitude of the camera 11 based on the pairs of parallel line segments, a pair of the optical flows Op1 and Op2 is a correct combination (hereinafter, referred to as a “correct flow”) in the attitude estimation. By contrast, for example, a pair of the optical flows Op1 and Op3 is an incorrect combination (hereinafter, referred to as a “false flow”).

Based on such a false flow, the attitude of the camera 11 cannot be correctly estimated. The rotation angles of the pan, tilt, and roll axes for each of the extracted optical flow pairs are estimated, and, based on a median value of a histogram, axis misalignment of the attitude of the camera 11 is determined. Consequently, the attitude estimation of the camera 11 may be less accurate with more false flows.

To address this, instead of the rectangular ROI 30-1, an ROI 30 is considered to be set in accordance with the shape of the road surface appearing in the captured image. In this case, however, if calibration values (mounting position as well as pan, tilt, and roll) of the camera 11 are not known in the first place, the ROI 30 in accordance with the shape of the road surface (hereinafter, referred to as a “road surface ROI 30-2”) cannot be set.

Thus, in the attitude estimation method according to the embodiment, a controller 15 included in the onboard device 10 (refer to FIG. 4) performs a first attitude estimation process using the rectangular ROI 30-1 set in a rectangular shape when the camera 11 is in an early stage after mounting, and performs a second attitude estimation process using a superimposed ROI 30-S set in accordance with the shape of the road surface when the camera 11 is not in the early stage after mounting.

Here, being “in the early stage after mounting” refers to a case where the camera 11 is mounted in a “first state”. The “first state” is the state in which the camera 11 is presumed to be in the early stage after mounting. For example, the first state is a state in which the time elapsed since the camera 11 was mounted is less than a predetermined elapsed time. For example, the first state is a state in which a number of calibration times since the camera 11 was mounted is less than a predetermined number of times. By contrast, being “not in the early stage after mounting” refers to a case where the camera 11 is mounted in a “second state”, which is different from the first state.

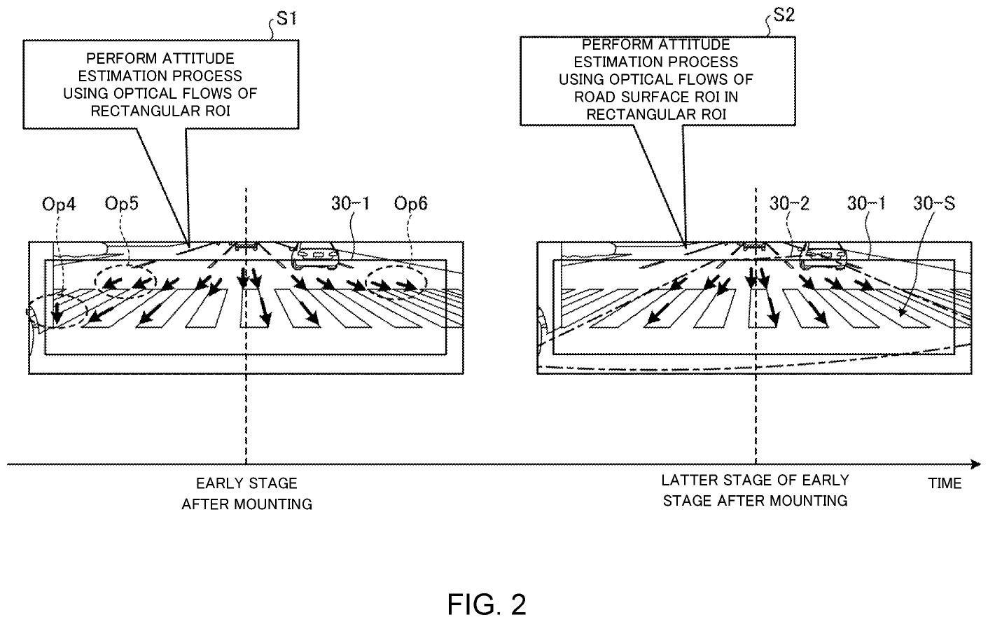

Specifically, as illustrated in FIG. 2, in the attitude estimation method according to the embodiment, when the camera 11 is in the early stage after mounting, the controller 15 performs the attitude estimation process using optical flows of the rectangular ROI 30-1 (a step S1). When the camera 11 is not in the early stage after mounting, the controller 15 performs the attitude estimation process using optical flows of the road surface ROI 30-2 in the rectangular ROI 30-1 (a step S2). The road surface ROI 30-2 in the rectangular ROI 30-1 refers to the superimposed ROI 30-S, which is a superimposed portion where the rectangular ROI 30-1 and the road surface ROI 30-2 overlap.

As illustrated in FIG. 2, using the optical flows of the superimposed ROI 30-S results in fewer false flows. For example, optical flows Op4, Op5, and Op6, which are included in the processing target in the step S1, are no longer included in the step S2.

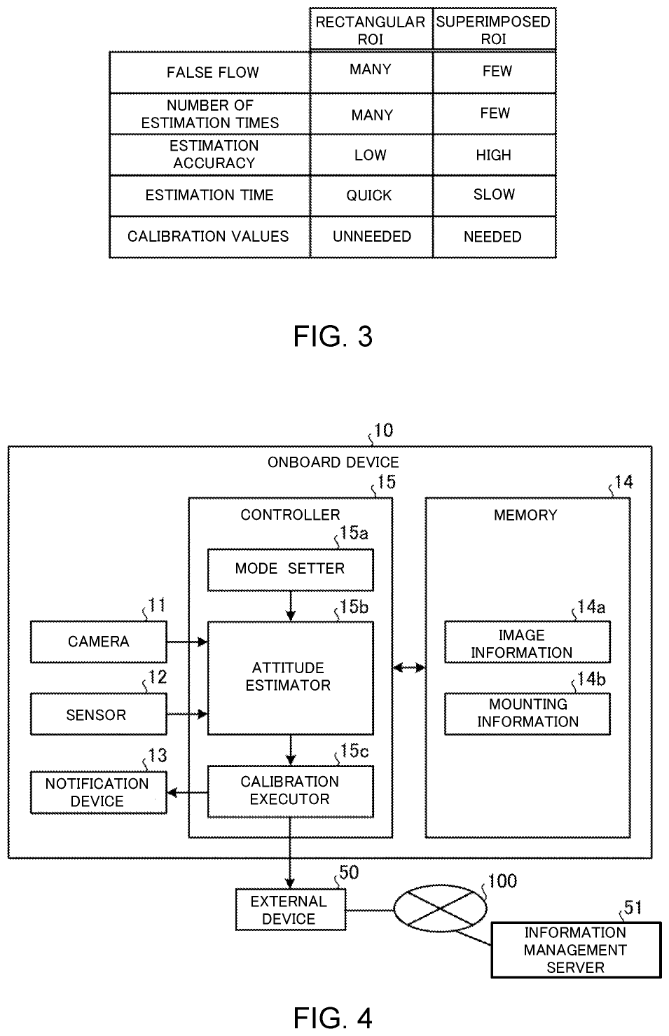

FIG. 3 illustrates a comparison between a case with the rectangular ROI 30-1 and a case with the superimposed ROI 30-S. When the superimposed ROI 30-S is used, there are fewer false flows, a fewer number of estimation times, and higher estimation accuracy than when the rectangular ROI 30-1 is used. However, the estimation time is slow and calibration values are needed.

Nevertheless, those disadvantages of estimation time and calibration values are compensated for by the attitude estimation process using the rectangular ROI 30-1 being performed when the camera 11 is in the early stage after mounting in the step S1.

That is, with the attitude estimation method according to the embodiment, an accuracy of the attitude estimation of the camera 11 can be improved while respective disadvantages of using the rectangular ROI 30-1 and of using the superimposed ROI 30-S are compensated for by the advantages of the other.

In this manner, in the attitude estimation method according to the embodiment, the controller 15 performs the first attitude estimation process using the rectangular ROI 30-1 set in a rectangular shape when the camera 11 is in the early stage after mounting, and performs the second attitude estimation process using the superimposed ROI 30-S set in accordance with the shape of the road surface when the camera 11 is not in the early stage after mounting.

Therefore, with the attitude estimation method according to the embodiment, the accuracy of the attitude estimation of the camera 11 can be improved.

An example configuration of the onboard device 10 to which the aforementioned attitude estimation method according to the embodiment is applied will be described more specifically below.

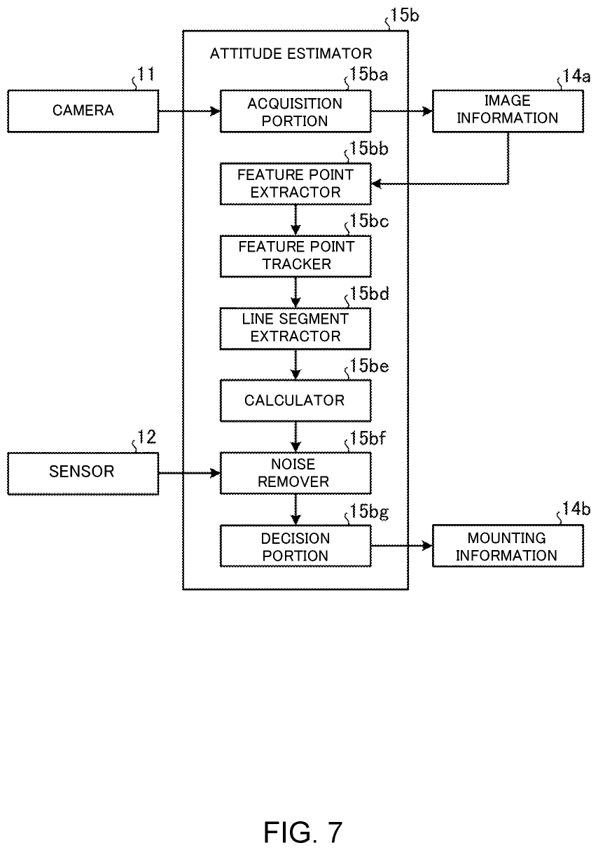

FIG. 4 is a block diagram illustrating the example configuration of the onboard device 10 according to the embodiment. In FIG. 4 and in FIG. 7 to be illustrated later, only the components needed to describe the features of the present embodiment are illustrated, and the description of general components is omitted.

In other words, each of the components illustrated in FIG. 4 and FIG. 7 are functional concepts and do not necessarily have to be physically configured as illustrated. For example, the specific form of distribution and integration of blocks is not limited to that illustrated in the figures, but can be configured by distributing and integrating all or part of the blocks functionally or physically in any units in accordance with various loads and usage conditions.

In the description using FIG. 4 and FIG. 7, components that have already been described may be simplified or omitted.

As illustrated in FIG. 4, the onboard device 10 according to the embodiment has the camera 11, a sensor 12, a notification device 13, a memory 14, and the controller 15.

The camera 11 includes an image sensor such as a charge coupled device (CCD) or a complementary metal oxide semiconductor (CMOS), for example, and uses such an image sensor to capture images of a predetermined imaging area. The camera 11 is mounted at various locations on the vehicle, such as the windshield or the dashboard, for example, so as to capture the predetermined imaging area in the front of the vehicle.

The sensor 12 is a variety of sensors mounted on the vehicle and includes, for example, a vehicle speed sensor and a G-sensor. The notification device 13 notifies information about calibration. The notification device 13 is implemented by, for example, a display or a speaker.

The memory 14 is implemented by a memory device such as random-access memory (RAM) and flash memory. The memory 14 stores image information 14a and mounting information 14b in the example of FIG. 4.

The image information 14a stores images captured by the camera 11. Thus, when the vehicle on which the onboard device 10 is mounted encounters an accident, the image information 14a is output and used to reproduce accident situations and investigate causes of the accident.

The mounting information 14b is information about mounting of the camera 11. The mounting information 14b includes design values for the mounting position and attitude of the camera 11 and the calibration values described above. The mounting information 14b may further include various information that may be used to determine whether the camera 11 is in the early stage after mounting, such as the date and time of mounting, the time elapsed since the camera 11 was mounted, and the number of calibration times since the camera 11 was mounted.

The controller 15 is implemented by, for example, a central processing unit (CPU) or a micro processing unit (MPU) executing a computer program (not illustrated) according to the embodiment stored in the memory 14 with RAM as a work area. The controller 15 can be implemented by an integrated circuit such as an application specific integrated circuit (ASIC) or a field programmable gate array (FPGA).

The controller 15 has a mode setter 15a, an attitude estimator 15b, and a calibration executor 15c and realizes or performs functions and actions of information processing described below.

The mode setter 15a sets an attitude estimation mode, which is an execution mode of the attitude estimator 15b, to a first mode when the camera 11 is in the early stage after mounting. The mode setter 15a sets the attitude estimation mode of the attitude estimator 15b to a second mode when the camera 11 is not in the early stage after mounting.

The attitude estimator 15b performs the first attitude estimation process using the optical flows of the rectangular ROI 30-1, when the execution mode is set to the first mode. The attitude estimator 15b performs the second attitude estimation process using the optical flows of the road surface ROI 30-2 in the rectangular ROI 30-1 (i.e., the superimposed ROI 30-S), when the execution mode is set to the second mode.

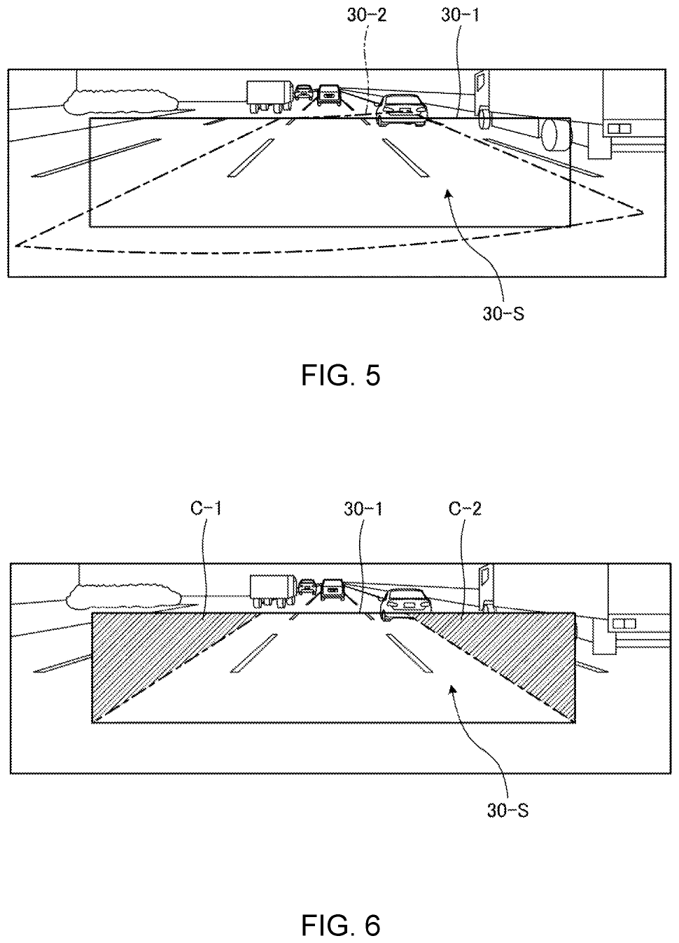

Here, the road surface ROI 30-2 and the superimposed ROI 30-S will be described specifically. FIG. 5 is an illustration (No. 1) of the road surface ROI30-2 and the superimposed ROI30-S. FIG. 6 is also an illustration (No. 2) of the road surface ROI30-2 and the superimposed ROI30-S.

As illustrated in FIG. 5, the road surface ROI 30-2 is set as the ROI 30 in accordance with the shape of the road surface appearing in the captured image. The road surface ROI 30-2 is set based on known calibration values so as to be a region about half a lane to one lane to the left and right from the lane in which the vehicle is traveling and about 20 m deep.

As illustrated in FIG. 5, the superimposed ROI 30-S is a superimposed portion where the rectangular ROI 30-1 and the road surface ROI 30-2 overlap. Expressed more abstractly, the superimposed ROI 30-S can be said to be a trapezoidal region in which an upper left region C-1 and an upper right region C-2 are removed from the rectangular ROI 30-1, as illustrated in FIG. 6. By removing the upper left region C-1 and the upper right region C-2 from the rectangular ROI 30-1 and using the resulting region as a region of interest for the attitude estimation process, false flows can occur less frequently, and the accuracy of the attitude estimation can be improved.

An example configuration of the attitude estimator 15b will be described more specifically. FIG. 7 is a block diagram illustrating the example configuration of the attitude estimator 15b. As illustrated in FIG. 7, the attitude estimator 15b has an acquisition portion 15ba, a feature point extractor 15bb, a feature point tracker 15bc, a line segment extractor 15bd, a calculator 15be, a noise remover 15bf, and a decision portion 15bg.

The acquisition portion 15ba acquires images captured by the camera 11 and stores the images in the image information 14a. The feature point extractor 15bb sets an ROI 30 corresponding to the execution mode of the attitude estimator 15b for each captured image stored in the image information 14a. The feature point extractor 15bb also extracts feature points included in the set ROI 30.

The feature point tracker 15bc tracks each feature point extracted by the feature point extractor 15bb across frames and extracts an optical flow for each feature point. The line segment extractor 15bd removes noise components from the optical flow extracted by the feature point tracker 15bc and extracts a group of line segment pairs based on the optical flow.

For each of the pairs of line segments extracted by the line segment extractor 15bd, the calculator 15be calculates rotation angles of the pan, tilt, and roll axes by using the algorithm in a non-patent document 1.

The noise remover 15bf removes noise portions due to the low speed and steering angle of the angles calculated by the calculator 15be based on sensor values of the sensor 12. The decision portion 15bg makes a histogram of each angle from which the noise portions have been removed, and determines angle estimates for pan, tilt, and roll based on the median values. The decision portion 15bg stores the determined angle estimates in the mounting information 14b.

The description returns to FIG. 4 now. The calibration executor 15c performs calibration based on the estimation results by the attitude estimator 15b. Specifically, the calibration executor 15c compares the angle estimate estimated by the attitude estimator 15b with the design value included in the mounting information 14b, and corrects the error.

The calibration executor 15c performs the first calibration process based on the estimated attitude of the camera 11 for a predetermined period in which the camera 11 is mounted in the first state, that is, for a first predetermined period after mounting of the camera 11.

Subsequently, the calibration executor 15c performs the second calibration process based on the estimated attitude of the camera 11 for a second predetermined period in which the camera 11 is mounted in the second state.

That is, the calibration executor 15c performs the second calibration process more detailed than the first calibration process for the second predetermined period after the first calibration process has been completed. As described above, the controller 15 sequentially performs the first calibration process and the second calibration process.

The calibration executor 15c notifies an external device 50 of a corrected calibration value and changes a detection accuracy of an image recognition process by the external device 50 depending on completion statuses of the first calibration process and the second calibration process.

The external device 50 is, for example, devices that perform driving support of the vehicle with obstacle detection, parking frame detection, autonomous driving, automatic parking functions, and so on, by performing the image recognition process on the captured image captured by the camera 11. The external device 50 is, for example, connected to an information management server 51 via a communication network 100, such as an internet, to conduct wireless communication.

With the onboard device 10 according to the embodiment, even when the calibration process of the camera 11 has not completely ended, by allowing the external device 50 to perform the image recognition process according to the stages of the calibration process, it is possible to allow the driving support by the external device 50 to be started earlier.

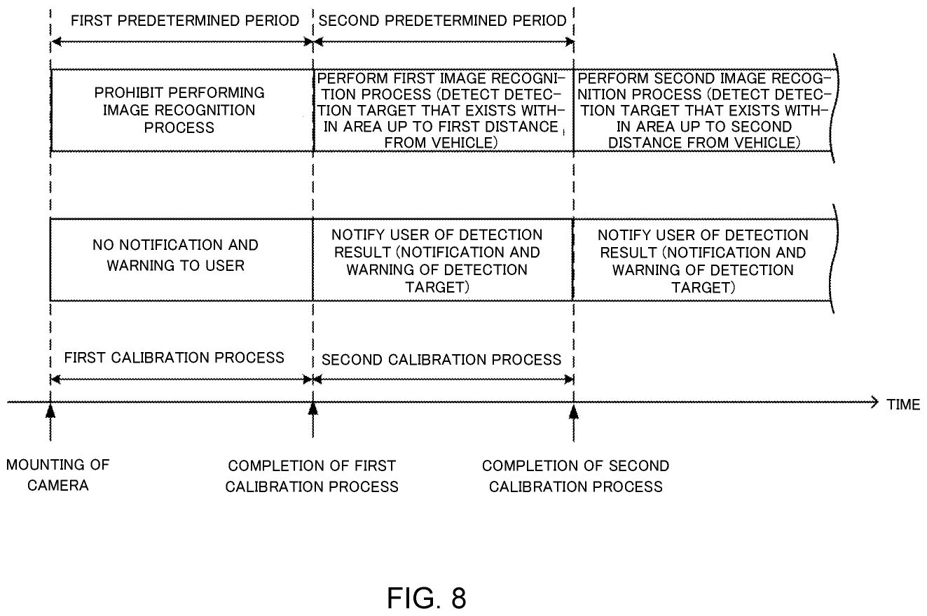

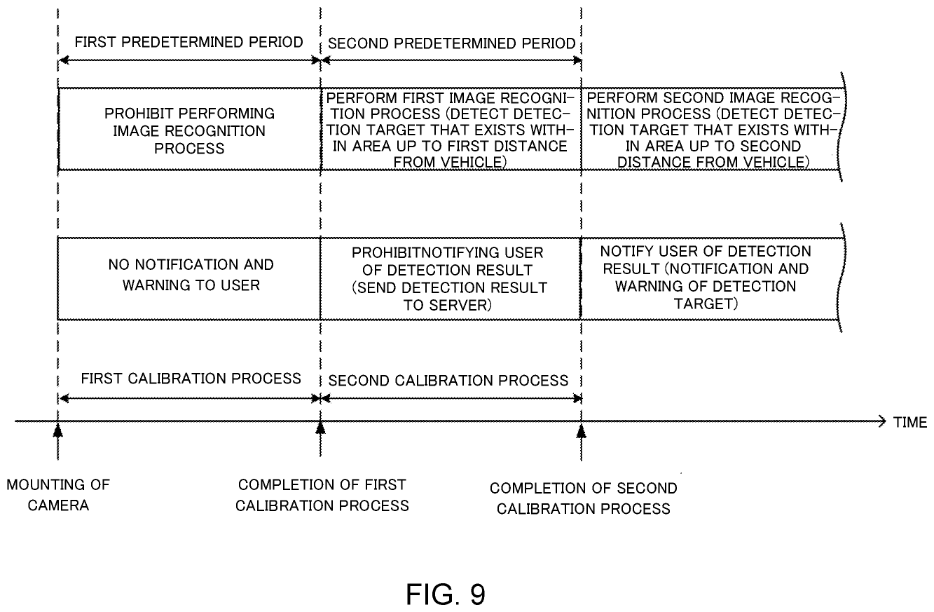

Here, one example of an instruction on the image recognition process to the external device 50 performed by the onboard device 10 according to the stages of the calibration process will be described with reference to FIG. 8 and FIG. 9. FIG. 8 and FIG. 9 are illustrations of one example of the instruction from the onboard device 10 according to the embodiment to the external device 50.

As illustrated in FIG. 8, the calibration executor 15c performs the first calibration process for the first predetermined period after mounting of the camera 11. Then, the calibration executor 15c issues an instruction that prohibits the external device 50 from performing the image recognition process until the first calibration process is completed.

Accordingly, since the external device 50 does not detect a detection target by the image recognition process, the external device 50 does not notify a user of the detection target (e.g., obstacles, etc.) and does not warn the user. That is, the external device 50 does not even complete the first calibration process until the first predetermined period elapses after mounting of the camera 11. Since a detection accuracy of a target by the image recognition process is relatively low, the external device 50 does not perform the driving support.

Thus, the onboard device 10 prevents the external device 50 with a low detection accuracy from mistakenly notifying and waning the user of an existence of a detection target that does not actually exist.

Subsequently, when the first calibration process has been completed, the calibration executor 15c performs the second calibration process more detailed than the first calibration process for the second predetermined period after completion of the first calibration process.

Then, the calibration executor 15c instructs the external device 50 to perform a first image recognition process until the second calibration process is completed. At this time, the calibration executor 15c allows the external device 50 to perform the first image recognition process of detecting a detection target that exists within an area up to a first predetermined distance (e.g., 5 m) from the camera 11 and notifying (warning) the user of the detection result.

Thus, the onboard device 10 allows the external device 50 to notify the user of the existence of the detection target within a relatively short distance that is detected by the external device 50 with a higher detection accuracy of an object than when the first calibration has not completed.

That is, even when the calibration process has not completely ended, since the onboard device 10 allows the external device 50 to notify the user of the detection result depending on the detection accuracy of the detection target, it is possible to start the driving support earlier.

Furthermore, when the calibration process has not completely ended, the onboard device 10 does not allow the external device 50 with insufficient detection accuracy of the detection target in a long distance to detect the detection target that exists farther than the first predetermined distance. As a result, the onboard device 10 prevents the external device 50 from mistakenly notifying and warning the user of the existence of the detection target in a long distance that does not actually exist.

Subsequently, after the second calibration process has been completed, the calibration executor 15c instructs the external device 50 to perform a second image recognition process with a higher sensitivity than the first image recognition process.

At this time, the calibration executor 15c allows the external device 50 to perform the second image recognition process of detecting a detection target that exists within an area up to a second predetermined distance (e.g., 10 m) from the camera 11 that is longer than the first predetermined distance (e.g., 5 m) and notifying (warning) the user of the detection result.

Thus, the onboard device 10 allows the external device 50 to appropriately notify the user of the existence of the detection target in a relatively long distance that is detected by the external device 50 when the calibration process has completely ended.

FIG. 8 illustrates one example of the instruction on the image recognition process to the external device 50. For example, the calibration executor 15c may give the instruction illustrated in FIG. 9 to the external device 50.

For example, as illustrated in FIG. 9, the calibration executor 15c may give an instruction similar to that shown in FIG. 8 to the external device 50 until the first predetermined period elapses after mounting of the camera 11 and then may give an instruction different from that shown in FIG. 8 for the second predetermined period.

Specifically, the calibration executor 15c instructs the external device 50 to perform the first image recognition process for the second predetermined period until the second calibration process is completed after the first calibration process has been completed. However, the calibration executor 15c prohibits the external device 50 from notifying the user of the detection result and instructs the external device 50 to send the detection result to the information management server 51.

As a result, the onboard device 10 prevents the external device 50 with the low detection accuracy from notifying the user of an uncertain detection result. By sending the uncertain detection result to the information management server 50, it is possible to utilize the uncertain detection result for investigating causes of an accident. In this case, the calibration executor 15c gives the instruction similar to that shown in FIG. 8 to the external device 50 after the second calibration process has been completed.

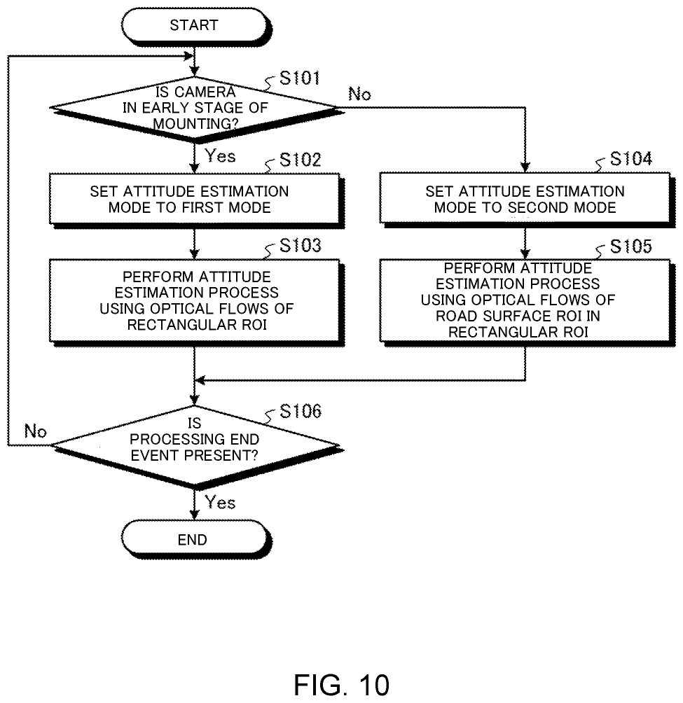

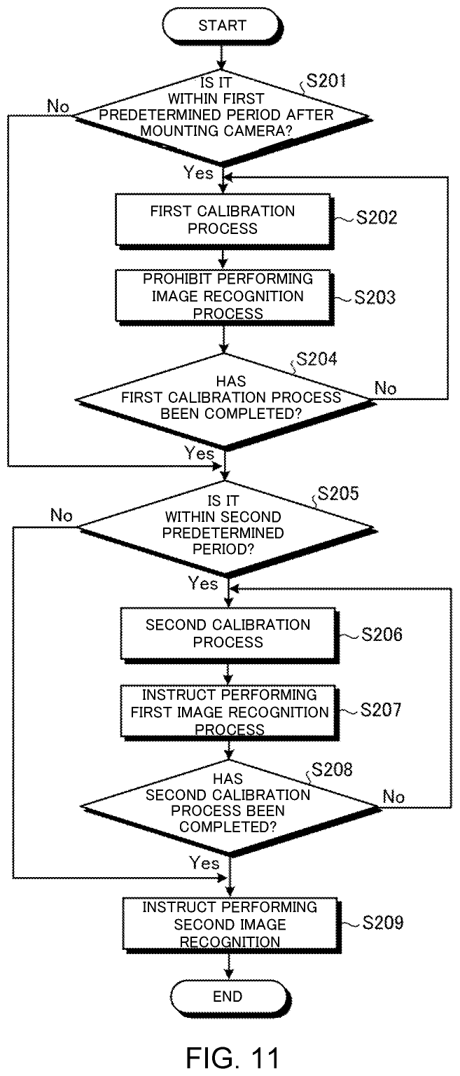

Next, a processing procedure performed by the onboard device 10 will be described with reference to FIG. 10 and FIG. 11. FIG. 10 and FIG. 11 are flowcharts illustrating the processing procedure performed by the onboard device 10 according to the embodiment.

As illustrated in FIG. 10, the controller 15 of the onboard device 10 determines whether or not the camera 11 is in the early state after mounting (a step S101). When the camera 11 is in the early stage after mounting (Yes in the step S101), the controller 15 sets the attitude estimation mode to the first mode (a step S102).

The controller 15 then performs the attitude estimation process using the optical flows of the rectangular ROI 30-1 (a step S103). When the camera 11 is not in the early stage after mounting (No in the step S101), the controller 15 sets the attitude estimation mode to the second mode (a step S104).

The controller 15 then performs the attitude estimation process using the optical flows of the road surface ROI 30-2 in the rectangular ROI 30-1 (a step S105). The controller 15 determines whether or not a processing end event is present (a step S106).

A processing end event is, for example, the arrival of a non-execution time period for the attitude estimation process, engine shutdown, or power off. When a processing end event has not occurred (No in the step S106), the controller 15 repeats the process from the step S101. When a processing end event has occurred (Yes in the step S106), the controller 15 ends the process.

The controller 15 performs the process shown in FIG. 11 in parallel with the process shown in FIG. 10. As illustrated in FIG. 11, the controller 15 determines whether or not it is within the first predetermined period after mounting of the camera 11 (a step S201). When the controller 15 has determined that it is not within the first predetermined period after mounting of the camera 11 (No in the step S201), the controller 15 moves the process to the step S205.

When the controller 15 has determined that it is within the first predetermined period after mounting of the camera 11 (Yes in the step S201), the controller performs the first calibration process (a step S202). The controller 15 then issues the instruction that prohibits the external device 50 from performing the image recognition process (a step S203).

Subsequently, the controller 15 determines whether or not the first calibration process has been completed (a step S204). When the controller 15 has determined that the first calibration process has not completed (No in the step S204), the controller 15 moves the process to the step S202.

When the controller 15 has determined that the first calibration process has been completed (Yes in the step S204), the controller 15 then determines whether or not it is within the second predetermined period (a step S205). When the controller 15 has determined that it is not within the second predetermined period (No in the step S205), the controller 15 moves the process to a step S209.

When the controller 15 has determined that it is within the second predetermined period (Yes in the step S205), the controller 15 performs the second calibration process (a step S206). The controller 15 then instructs the external device 50 to perform the first image recognition process (a step S207).

Subsequently, the controller 15 determines whether or not the second calibration process has been completed (a step S208). When the controller has determined that the second calibration process has not completed (No in the step S208), the controller 15 moves the process to the step S206.

When the controller 15 has determined that the second calibration process has been completed (Yes in the step S208), the controller 15 instructs the external device 50 to perform the second image recognition process (the step S209), and ends the process.

The computer program according to the embodiment can be recorded on a computer-readable recording medium, such as a hard disk, a flexible disk (FD), CD-ROM, a magneto-optical disk (MO), a digital versatile disc (DVD), and a universal serial bus (USB) memory, and can be executed by the computer reading from the recording medium.

As to implementations containing the above embodiments, following supplements are further disclosed.

1. An information processing apparatus includes:
a controller configured to (i) sequentially perform a first calibration process and a second calibration process of an onboard camera, and (ii) change a detection accuracy of an image recognition process of a captured image captured by the onboard camera depending on completion statuses of the first calibration process and the second calibration process.

2. The information processing apparatus according to supplement 1, wherein
the first calibration process is performed based on a coarse optical flow or an optical flow in a rectangular region of images captured by the onboard camera, and the second calibration process is performed based on a fine optical flow or an optical flow on a road surface in the rectangular region of the images captured by the onboard camera.

3. The information processing apparatus according to supplement 2, wherein
the controller is configured to (i) perform the first calibration process for a first predetermined period after mounting of the onboard camera, (ii) prohibit performing the image recognition process until the first calibration process is completed, (iii) perform the second calibration process for a second predetermined period after the first calibration process has been completed, (iv) allow a first image recognition process to be performed until the second calibration process is completed after the first calibration process has been completed, and (v) allow a second image recognition process with a higher detection accuracy than the first image recognition process to be performed after the second calibration process has been completed.

4. The information processing apparatus according to supplement 3, wherein
the first image recognition process is a process of detecting a detection target that exists within an area up to a first predetermined distance from the onboard camera and notifying a user of a detection result, and
the second image recognition process is a process of detecting a detection target that exists within an area up to a second predetermined distance from the onboard camera that is longer than the first predetermined distance and notifying the user of a detection result.

5. The information processing apparatus according to supplement 3, wherein
the first image recognition process is a process of detecting a detection target and prohibiting notification of a detection result to a user, and
the second image recognition process is a process of detecting a detection target and notifying the user of a detection result.

6. The information processing apparatus according to supplement 5, wherein
the controller is configured to allow results of the first image recognition process and the second image recognition process to be sent to a server.

7. The information processing apparatus according to any one of supplements 1 to 6, wherein
the controller includes a memory that stores the captured image captured by the onboard camera.

8. An information processing method performed by a controller of an information processing apparatus, the method includes the steps of:
(a) sequentially performing a first calibration process and a second calibration process of an onboard camera; and
(b) changing a detection accuracy of an image recognition process of a captured image captured by the onboard camera depending on completion statuses of the first calibration process and the second calibration process.

9. The information processing method according to supplement 8, wherein
the method includes performing the first calibration process based on a coarse optical flow or an optical flow in a rectangular region of images captured by the onboard camera, and performing the second calibration process based on a fine optical flow or an optical flow on a road surface in the rectangular region of the images captured by the onboard camera.

10. A computer-readable recording medium having stored therein a program that causes a computer to execute a process, the process includes:
(i) sequentially performing a first calibration process and a second calibration process of an onboard camera; and
(ii) changing a detection accuracy of an image recognition process of a captured image captured by the onboard camera depending on completion statuses of the first calibration process and the second calibration process.

It is possible for a person skilled in the art to easily come up with more effects and modifications. Thus, a broader modification of this invention is not limited to specific description and typical embodiments described and expressed above. Therefore, various modifications are possible without departing from the general spirit and scope of the invention defined by claims attached and equivalents thereof.

While the invention has been shown and described in detail, the foregoing description is in all aspects illustrative and not restrictive. It is therefore understood that numerous other modifications and variations can be devised without departing from the scope of the invention.

1. An information processing apparatus comprising:
a controller configured to (i) perform a first image recognition process after completion of a first calibration process, which is performed according to an installation of an onboard camera, (ii) perform a second calibration process after completion of the first calibration process, and (iii) perform a second image recognition process within a range different from the first image recognition process after completion of the second calibration process.

2.-10. (canceled)

11. The information processing apparatus according to claim 1, wherein
the second calibration process is more detailed than the first calibration process.

12. The information processing apparatus according to claim 1, wherein
the first calibration process is performed in a rectangular region of images captured by the onboard camera, and the second calibration process is performed on a road surface in the rectangular region of the images captured by the onboard camera.

13. The information processing apparatus according to claim 1, wherein
the second image recognition process has a higher sensitivity than the first image recognition process.

14. The information processing apparatus according to claim 1, wherein
the controller is configured to prohibit performing of the first image recognition process until the first calibration process is completed.

15. The information processing apparatus according to claim 1, wherein
the controller is configured to perform the first image recognition process during performing of the second calibration process.

16. The information processing apparatus according to claim 1, wherein
the controller is configured to notify a user of a result of the first image recognition process or the second image recognition process.

17. The information processing apparatus according to claim 1, wherein
the controller is configured to allow results of the first image recognition process and of the second image recognition process to be sent to a server.

18. An information processing method performed by a controller of an information processing apparatus, the method comprising the steps of:
(a) performing a first image recognition process after completion of a first calibration process, which is performed according to an installation of an onboard camera;
(b) performing a second calibration process after completion of the first calibration process; and
(c) performing a second image recognition process within a range different from the first image recognition process after completion of the second calibration process.

19. The information processing method according to claim 18, wherein
the second calibration process is more detailed than the first calibration process.

20. The information processing method according to claim 18, wherein
the first calibration process is performed in a rectangular region of images captured by the onboard camera, and the second calibration process is performed on a road surface in the rectangular region of the images captured by the onboard camera.

21. The information processing method according to claim 18, wherein
the second image recognition process has a higher sensitivity than the first image recognition process.

22. A computer-readable recording medium having stored therein a program that causes a computer to execute a process, the process comprising:
(i) performing a first image recognition process after completion of a first calibration process, which is performed according to an installation of an onboard camera;
(ii) performing a second calibration process after completion of the first calibration process; and
(iii) performing a second image recognition process within a range different from the first image recognition process after completion of the second calibration process.
